(19) United States
(12) Patent Application Publication
(10) Pub. No.: US 2011/0038006 A1
(43) Pub. Date: Feb. 17, 2011

(54) IMAGE PROCESSING APPARATUS, CONTROL METHOD OF IMAGE PROCESSING APPARATUS, AND PROGRAM

(75) Inventor: Masayuki Sato, Tokyo (JP)

Correspondence Address: FITZPATRICK CELLA HARPER & SCINTO, 1290 Avenue of the Americas, NEW YORK, NY, 10104-3800, US

(73) Assignee: Canon Kabushiki Kaisha, Tokyo (JP)

(21) Appl. No.: 12/989,632

(22) PCT Filed: Jun. 26, 2009
(86) PCT No.: PCT/JP2009/062166

§ 371 Date: Oct. 25, 2010

(30) Foreign Application Priority Data
Jun. 30, 2008 (JP) 2008-171738

(51) Int. Cl. G06F 3/12

(52) U.S. Cl. 358/1.15

(57) ABSTRACT

The invention enables a user to perform a process to image data stored in an image inputting apparatus even if the user does not leave the image inputting apparatus being close to an image processing apparatus. To achieve this, the image processing apparatus capable of performing wireless communication with the image inputting apparatus is controlled by: automatically obtaining all of printable image data stored in the image inputting apparatus, according to a status that the image processing apparatus comes to be able to communicate with the image inputting apparatus; accepting, from the user, an instruction of the process to the obtained image data; and performing the process to the obtained image data according to the accepted instruction.

### TECHNICAL FIELD

The present invention relates to an image processing apparatus, a control method of the image processing apparatus, and a program for achieving the control method.

### BACKGROUND ART

Conventionally, in a case where image data stored in an image inputting apparatus such as a digital camera or the like is printed by an image processing apparatus such as an MFP (Multifunction Peripheral) or the like, a user can perform the printing according to, for example, a method as described below. That is, according to this method, the user can transfer the image data stored in the image inputting apparatus to a portable medium such as an SD (secure digital) memory card or the like, select the image data intended to be printed in a status that the relevant portable medium is being connected to the image processing apparatus, and print the selected image data.

Further, as a method of transferring image data between apparatuses, for example, Japanese Patent Application Laid-Open No. 2008-099236 proposes a method of performing high-speed wireless communication between apparatuses mutually positioned at a short distance. If such a mechanism is adopted to the image inputting apparatus such as the digital camera or the like, the user can perform an operation to the image data stored in the image inputting apparatus only by disposing the image inputting apparatus in the vicinity of a communication unit of the image processing apparatus.

However, in a case where the user disposes the image inputting apparatus in the vicinity of the communication unit of the image processing apparatus and then performs the operation to the image data stored in the image inputting apparatus, it is necessary to keep placing the image inputting apparatus in the vicinity of the communication unit while the user is selecting the image data intended to be printed or performing print setting.

In the case where the user performs the operation with the image inputting apparatus placed, there is a fear that the image inputting apparatus which is being placed is stolen by a third person in, for example, a convenience shop, or an open space such as an airport, a hotel or the like. Further, in the case where the user performs the operation while the image inputting apparatus is being placed, there is a fear that the user forgets the placed image inputting apparatus after completion of the operation to the image data.

### DISCLOSURE OF THE INVENTION

The present invention provides an image processing apparatus and a control method of the image processing apparatus, which overcome such conventional problems as described above.

An object of the present invention is to provide an image processing apparatus which can perform wireless communication with an image inputting apparatus, comprising: an obtaining unit configured to automatically obtain all of printable image data stored in the image inputting apparatus, according to a status that the image processing apparatus comes to be able to communicate with the image inputting apparatus; an accepting unit configured to accept, from a user, an instruction of a process to the image data obtained by the obtaining unit; and a processing unit configured to perform the process to the image data obtained by the obtaining unit, according to the instruction accepted by the accepting unit.

Further objects and features of the present invention will become apparent from the following description of the exemplary embodiments with reference to the attached drawings.

### BRIEF DESCRIPTION OF THE DRAWINGS

The accompanying drawings, which are incorporated in and constitute a part of the specification, illustrate the exemplary embodiments of the present invention and, together with the description of the specification, serve to explain the principle of the present invention.

FIG. 1 is a diagram illustrating a constitution of an image processing system according to the embodiment of the present invention.

FIG. 2 is a block diagram illustrating a constitution of an image processing apparatus according to the embodiment of the present invention.

FIG. 3 is a block diagram illustrating a constitution of a controller unit of the image processing apparatus according to the embodiment of the present invention.

FIG. 4 is a diagram illustrating a configuration of an operation unit of the image processing apparatus according to the embodiment of the present invention.

FIG. 5 is a block diagram illustrating a constitution of an image inputting apparatus according to the embodiment of the present invention.

FIG. 6 is a flow chart illustrating a data processing procedure according to the embodiment of the present invention.

FIG. 7 is a set of diagrams illustrating display screens according to the embodiment of the present invention.

FIG. 8 is a flow chart illustrating a data processing procedure according to another embodiment of the present invention.

FIG. 9 is a set of diagrams illustrating display screens according to another embodiment of the present invention.

FIG. 10 is a diagram for describing a memory map of a storage medium which stores therein a readable program according to the embodiment.

### BEST MODE FOR CARRYING OUT THE INVENTION

Hereinafter, the exemplary embodiments of the present invention will be described with reference to the attached drawings.

### First Embodiment

Initially, the first embodiment of the present invention will be described.

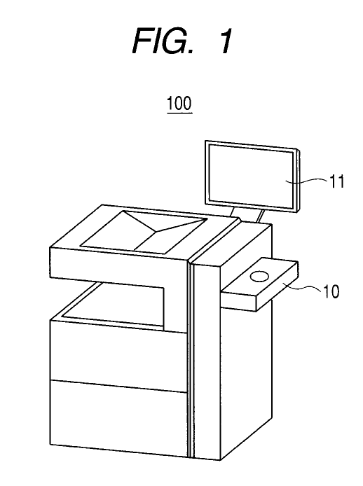

First, a constitution of an image processing apparatus according to the first embodiment of the present invention will be described with reference to FIG. 1. That is, FIG. 1 illustrates an appearance of an image processing apparatus 100 according to the present embodiment.

The image processing apparatus 100 comprises a communication unit 10 and a display unit 11.

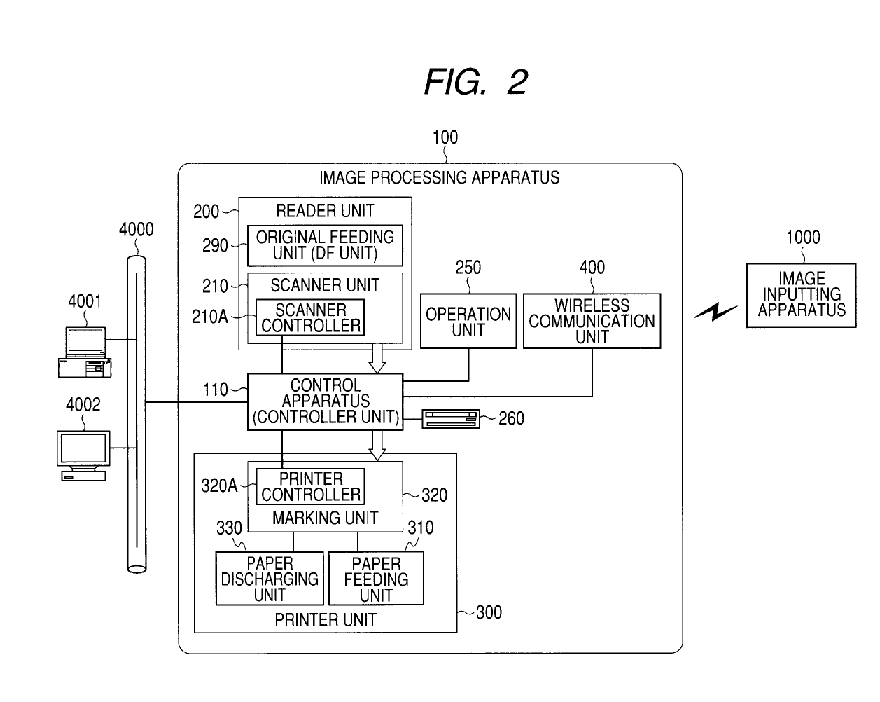

Here, the communication unit 10 is to perform wireless communication with an image inputting apparatuses such as a digital camera, a cellular phone, a PDA (personal digital assistant), a laptop computer and the like. That is, if a user brings an image inputting apparatus 1000 (FIG. 2) close to the communication unit 10 of the image processing apparatus 100, it becomes possible to perform communication between the image processing apparatus 100 and the image inputting apparatus 1000. Thus, it should be noted that the image processing apparatus 100 has been constituted to be able to perform the wireless communication with the image inputting apparatus 1000. Incidentally, in the following description, the image inputting apparatus 1000 will be occasionally called a digital camera 1000 according to the circumstances.

Further, the display unit 11 of the image processing apparatus 100 comprises a touch panel and an LCD (liquid crystal display) unit. The display unit 11 displays an operation screen and accepts instructions from the user. Further, the display unit 11 displays various statuses of the image processing apparatus 100.

Subsequently, a constitution of an image processing system which includes the image processing apparatus 100 and the image inputting apparatus 1000 will be described with reference to FIG. 2.

A control apparatus (controller unit) 110 is electrically connected to a reader unit 200 and a printer unit 300. Thus, information transferred from the reader unit 200 and/or the printer unit 300 is received by the controller unit 110, and various kinds of commands are transferred from the controller unit 110 to the reader unit 200 and/or the printer unit 300. Further, since the controller unit 110 is connected to PCs (personal computers) 4001 and 4002 through a network 4000 such as a LAN (local area network) or the like, image data and control commands transmitted from the PC 4001 and/or the PC 4002 through the network 4000 are received by the controller unit 110. Here, for example, the Ethernet™ is used as the above-described network.

An original image is optically read and converted into image data by the reader unit 200. Here, the reader unit 200 is constituted by a scanner unit 210 having a function to read an original and an original feeding unit {DF (document feeding) unit} 290 for transporting an original paper to a position at which the original image on the original paper can be read by the scanner unit 210.

The original feeding unit 290 and the scanner unit 210 are controlled by a scanner controller 210A on the basis of an instruction from the controller unit 110.

The printer unit 300 is constituted by a paper feeding unit 310 for holding therein printing papers, a marking unit 320 for transferring and fixing image data to a paper, and a paper discharging unit 330 for discharging image-printed papers. On the basis of an instruction from the controller unit 110, the papers are fed from the paper feeding unit 310, the image data are printed on the fed papers, and the image-printed papers are discharged by the paper discharging unit 330. Here, it should be noted that the marking unit 320 includes a controller 320A.

Incidentally, plural kinds of papers can be held by the paper feeding unit 310. Further, paper sorting and stapling can be performed to the image-printed papers by the paper discharging unit 330.

An operation unit 250, which corresponds to the display unit 11 illustrated in FIG. 1, is constituted by hard keys, and/or an LCD and a touch panel attached on the LCD, through which instructions by the user are accepted. Further, commands corresponding to the instructions accepted from the user are transferred to the controller unit 110, and various control operations according to the received commands are performed by the controller unit 110. Furthermore, soft keys for accepting the operations of the image processing apparatus 100, the functions of the image processing apparatus 100 and the statuses of the image processing apparatus 100 are displayed on the LCD of the operation unit 250.

Various kinds of settings for the image processing apparatus 100 and various kinds of image data are stored in an HDD (hard disk drive) 260.

In the image processing apparatus 100, for example, a copying function, an image data transmitting function, a printer function and the like are performed by using the above-described constitution. More specifically, in case of performing the copying function, the controller unit 110 causes the reader unit 200 to read the image data of the original, and causes the printer unit 300 to print the read image data on the paper. Further, in case of performing the image data transmitting function, the controller unit 110 converts the image data read by the reader unit 200 into code data, and transmits the converted code data to the PC 4001 and the PC 4002 through the network 4000. Furthermore, in case of performing the printer function, the controller unit 110 converts code data received from the PC 4001 and the PC 4002 through the network 4000 into image data by analyzing and extracting the received code data, and outputs the converted image data to the printer unit 300. Then, the printer unit 300 prints the image data received from the controller unit 110. In other words, it should be noted that the controller unit 110 acts as an image processing unit and the printer unit 300 acts as an image forming unit.

Incidentally, an MFP having plural functions is used as an example of the image processing apparatus 100 in the present embodiment. However, a copying machine having only the copying function or an SFP (Single Function Peripheral) having only the printer function may be used as the image processing apparatus 100.

A wireless communication unit 400, which is provided in the communication unit 10, detects that the image inputting apparatus 1000 is brought close to the communication unit 10, and transmits/receives control data, image data and the like to/from the image inputting apparatus 1000. Incidentally, the wireless communication unit 400 may be controlled based on an instruction from the control apparatus 110, or may be controlled by a CPU (central processing unit) which is independently provided in the wireless communication unit 400 itself.

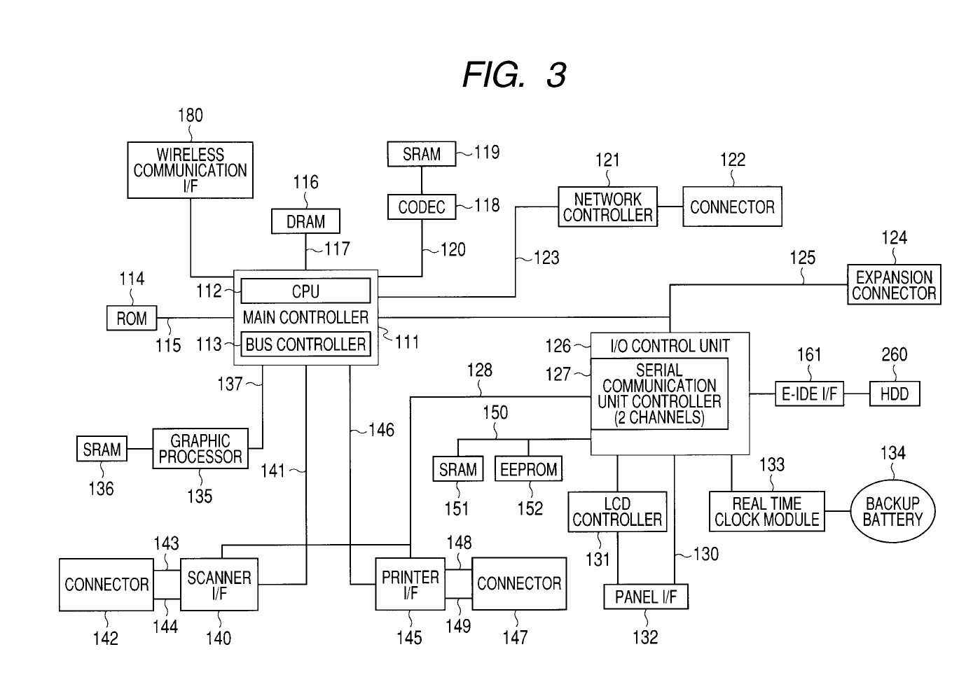

Subsequently, the constitution of the controller unit 110 will be described with reference to FIG. 3.

That is, a main controller 111 is constituted mainly by a CPU 112, a bus controller 113 and various kinds of I/F (interface) controller circuits.

The CPU 112 and the bus controller 113 totally control the whole operation of the controller unit 110. More specifically, the CPU 112 performs various operations based on the programs read from a ROM (read only memory) 114 through a ROM I/F 115. For example, the CPU 112 interprets the code data (for example, PDL (page description language) data) received from the PC 4001 or the PC 4002 illustrated in FIG. 1, and controls data storage operations of memories such as a DRAM (dynamic random access memory) 116, the HDD 260 and the like.

The bus controller 113 controls transfer of the data input/output from/to each I/F. Further, the bus controller 113 adjusts buses and controls DMA (direct memory access) data transfer.

The DRAM 116, which is connected to the main controller 111 through a DRAM I/F 117, is used as a working area for the operation of the CPU 112 and an area for storage of image data.

A codec 118 compresses raster image data stored in the DRAM 116 according to a compression method such as an MH (Modified Huffman) compression, an MR (Modified READ) compression, an MMR (Modified Modified READ) compression, a JBIG (Joint Bi-level Image Experts Group) compression, a JPEG (Joint Photographic Experts Group) compression, or the like. On the other hand, the codec 118 extracts code data compressed and stored into raster image data.

An SRAM (static random access memory) 119 is used as a temporary working area for the codec 118. Since the codec 118 is connected to the main controller 111 through an I/F 120, the data transfer between the codec 118 and the main controller 111 is controlled by the bus controller 113 in the form of DMA data transfer.

A graphic processor 135 performs various processes such as an image rotating process, an image magnification changing process, a color space converting process, a binarizing process and the like to the raster image data stored in the DRAM 116. An SRAM 136 is used as a temporary working area for the graphic processor 135. Since the graphic processor 135 is connected to the main controller 111 through an I/F 137, the data transfer between the graphic processor 135 and the DRAM 116 is controlled by the bus controller 113 in the form of DMA data transfer.

A network controller 121 is connected to the main controller 111 through an I/F 123. Also, the network controller 121 is connected to an external network such as the network 4000 by means of a connector 122.

An expansion connector 124 for connecting an expansion board and an I/O (input/output) control unit 126 are connected to each other through a general-purpose high-speed bus 125. Here, for example, a PCI (Peripheral Component Interconnect) bus is used as the general-purpose high-speed bus 125. The I/O control unit 126 is equipped with a two-channel asynchronous serial communication unit controller 127 for transmitting/receiving control commands to/from the CPU of each of the reader unit 200 and the printer unit 300. Further, the I/O control unit 126 is connected to a scanner I/F 140 and a printer I/F 145 through an I/O bus 128.

A panel I/F 132 is an I/F for transmitting/receiving various data to/from the operation unit 250 illustrated in FIG. 2. More specifically, the panel I/F 132 transfers the image data from an LCD controller 131 to the operation unit 250. Further, the panel I/F 132 transfers key inputting signals received through the keys such as the hard keys of the operation unit 250, the LCD touch panel keys and the like to the I/O control unit 126 through an I/F 130.

A real time clock module 133 is used to update and store dates and times to be managed in the MFP 100. Here, power is supplied to the real time clock module 133 by a backup battery 134.

An E-IDE (Enhanced Integrated Drive Electronics) I/F 161 is used to connect the HDD 260. That is, the CPU 112 stores/reads image data in/from the HDD 260 through the E-IDE I/F 161.

A connector 142 is connected to the reader unit 200, and a connector 147 is connected to the printer 300. The connector 142 consists of an asynchronous serial I/F 143 and a video I/F 144, and the connector 147 consists of an asynchronous serial I/F 148 and a video I/F 149.

The scanner I/F 140 is connected to the reader unit 200 through the connector 142, and is also connected to the main controller 111 through a scanner bus 141. The scanner I/F 140 performs a predetermined process to the image data received from the reader unit 200. Further, the scanner I/F 140 outputs a control signal generated based on a video control signal received from the reader unit 200 to the scanner bus 141. Here, the data transfer from the scanner bus 141 to the DRAM 116 is controlled by the bus controller 113.

The printer I/F 145 is connected to the printer unit 300 through the connector 147, and is also connected to the main controller 111 through a printer bus 146. The printer I/F 145 performs a predetermined process to the image data output from the main controller 111, and outputs the processed image data to the printer unit 300. Here, the transfer of the raster image data extracted on the DRAM 116 to the printer unit is controlled by the bus controller 113. Thus, the raster image data is transferred to the printer unit 300 in the form of DMA transfer through the printer bus 146, the printer I/F 145 and the video I/F 149.

Even if the power to the whole of the MFP 100 is interrupted, an SRAM 151 can hold the stored contents by the power supplied from a backup battery. The SRAM 151 is connected to the I/O control unit 126 through a bus 150.

Likewise, an EEPROM (electrically erasable and programmable read only memory) 152 is connected to the I/O control unit 126 through the bus 150.

A wireless communication I/F 180 is an I/F which transmits/receives data to/from the wireless communication unit 400 illustrated in FIG. 2. The CPU 112 receives the data from the wireless communication unit 400 through the wireless communication I/F 180. Further, the CPU 112 transfers the data to the wireless communication unit 400 through the wireless communication I/F 180.

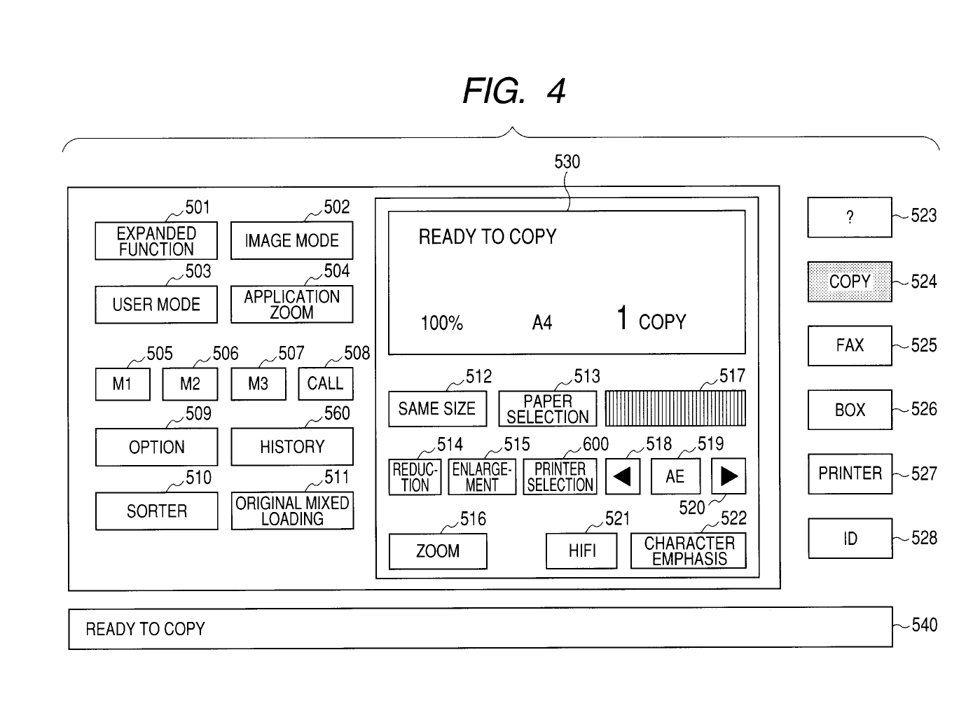

Subsequently, the operation unit 250 will be described with reference to FIG. 4. FIG. 4 is the diagram illustrating a screen to be displayed on the LCD unit having a touch panel. If a button (or a key) on the screen is depressed by the user, the CPU 112 detects it and thus performs the function corresponding to the depressed button.

A copy mode key 524 is a key which is depressed to perform the copying function. That is, if the copy mode key 524 is depressed, a copy mode screen 530 is displayed. An expanded function key 501 is a key which is depressed to enter various modes such as a double-sided copying mode, a multiple copying mode, an image shift mode, a binding margin setting mode, a frame deletion setting mode, and the like.

A status line 540 is a message box which displays a message indicating a status of the apparatus, print information or the like. In an example illustrated in FIG. 4, the status line 540 indicates that the apparatus is on standby for a copying operation.

An image mode key 502 is a key which is depressed to enter a setting mode of performing hatching, shadowing, trimming and/or masking to a copied image. A user mode key 503 is a key which is depressed to register mode memories, and/or perform setting of a standard mode screen. An application zoom key 504 is a key which is depressed to enter a mode of changing a magnification independently for each of X and Y directions of an original, and/or a zoom program mode of calculating a magnification based on an original size and a copying size. Further, an M1 key 505, an M2 key 506 and an M3 key 507 are keys which are depressed to call the respective registered mode memories. When the mode memory is actually called, a call key 508 is depressed. An option key 509 is a key which is depressed to perform settings for options such as a film projector to directly copy an image from a film. A sorter key 510 is a key which is depressed to perform a sort setting, a non-sort setting and a group sort setting. An original mixed loading key 511 is a key which is depressed to set different-sized originals together to the original feeding unit (for example, to mixedly loading an A4-sized original and an A3-sized original, or to mixedly loading a B5-sized original and a B4-sized original).

A same size key 512 is a key which is depressed to set a copy magnification to 100%, a reduction key 514 is a key which is depressed to perform typical size-reduction copying, and an enlargement key 515 is a key which is depressed to perform typical size-enlargement copying. A zoom key 516 is a key which is depressed to perform an operation for setting an arbitrary magnification, and a paper selection key 513 is a key which is depressed to select a desired copying paper. A density key 518 is a key which is depressed to gradually increase copy density, and a density key 520 is a key which is depressed to gradually decrease copy density. Here, a density display 517 is a copy density indicator which shifts from side to side according to the depression of the keys 518 and 520. An AE key 519 is a key which is depressed to instruct a process of performing automatic density adjustment to an original such as a newspaper of which the ground is relatively dark and copying the density-adjusted original. An HIFI (high fidelity) key 521 is a key which is depressed to copy an original such as a photographic image or the like of which the halftone density is high. A character emphasis key 522 is a key which is depressed to perform a process of emphasizing characters when copying a character original. A printer selection key 600 is a key which is depressed to select a proper printer.

A history key 560 is a key which is depressed to display history information of the job which has been printed. For example, if the history key 560 is depressed, information indicating an end time, a user name, a file name, print number and the like of a print job is displayed.

A guide key 523 is a key which is depressed if the user wishes explanation of the functions of the respective keys. That is, if the guide key 523 is depressed, the explanation of the function of the desired key is displayed. A fax key 525 is a key which is depressed to perform a facsimile operation. A box key 526 is a key which is depressed if the user wishes to display a box function. A printer key 527 is a key which is depressed to change a printing density or to refer to print output detailed information of PDL data sent from a host computer remotely located. An ID (identification) key 528 is a key which is depressed to instruct to display an ID (for example, a network address such as an IP (Internet Protocol) address, a machine name, or other information) of the image processing apparatus.

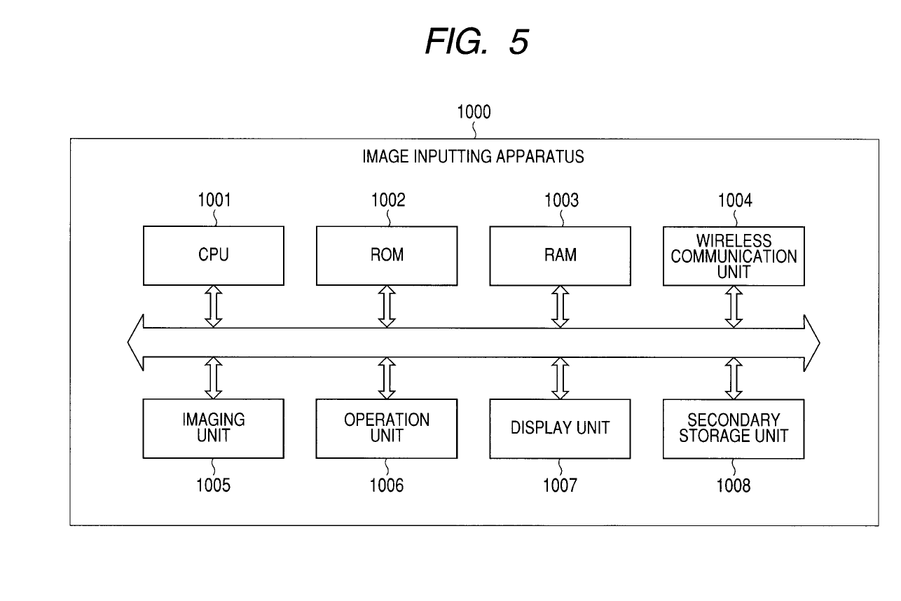

Subsequently, the constitution of the image inputting apparatus 1000 will be described with reference to FIG. 5.

As illustrated in FIG. 5, the image inputting apparatus 1000 includes a CPU 1001, a ROM 1002, a RAM (random access memory) 1003, a wireless communication unit 1004, an imaging unit 1005, an operation unit 1006, a display unit 1007 and a secondary storage unit 1008 which are mutually connected to others through a bus.

The CPU 1001, which operates according to the programs stored in the ROM 1002, controls various operations of the image inputting apparatus 1000.

The ROM 1002 is a nonvolatile memory which has stored therein the program to be executed by the CPU 1001.

The RAM 1003 functions as a working memory for the CPU 1001. Further, the RAM 1003 temporarily stores therein the image data output from the imaging unit 1005 and the image data read from the secondary storage unit 1008.

The wireless communication unit 1004, which includes an encoding/decoding circuit unit, an antenna and the like necessary for wireless communication, performs communication with an external apparatus which is located within a range communicable with the wireless communication unit 1004.

The imaging unit 1005 includes a lens for performing image formation based on incident light, a photoelectric converter (a CCD (charge coupled device), a CMOS (complementary metal-oxide semiconductor) sensor, or the like) for converting the image-formed light into an electrical signal, an A/D (analog-to-digital) converter for converting the analog electrical signal output from the photoelectric converter into a digital electrical signal, and the like. The CPU 1001 generates image data based on the digital electrical signal converted by the imaging unit 1005, adds the date at the time when the image data is shot, and setting data such as shooting conditions and the like to the generated image data as header information, and then stores the finally obtained image data in the secondary storage unit 1008 as one file.

The operation unit 1006 includes a release button for instructing image shooting, a mode selection dial for selecting an operation mode of the digital camera, a menu button for calling menu items, a button such as a cross-shaped cursor button for selecting and instructing the menu item, dials, switches and the like.

Here, it should be noted that the statuses and status changes of the buttons, the dials and the switches are output as the electrical signals to the CPU 1001. Then, the CPU 1001 performs controlling according to the instructions based on these electrical signals.

The display unit 1007, which consists of an LCD unit, displays the operation screen and the image data indicating the shot image.

The secondary storage unit 1008 stores therein the image data of the shot image, and the like as files. In any case, the secondary storage unit 1008 may be a built-in nonvolatile memory or a detachable memory card.

Incidentally, it is assumed that the respective units in the image inputting apparatus 1000 are powered by a power supply such as a not-illustrated battery or the like.

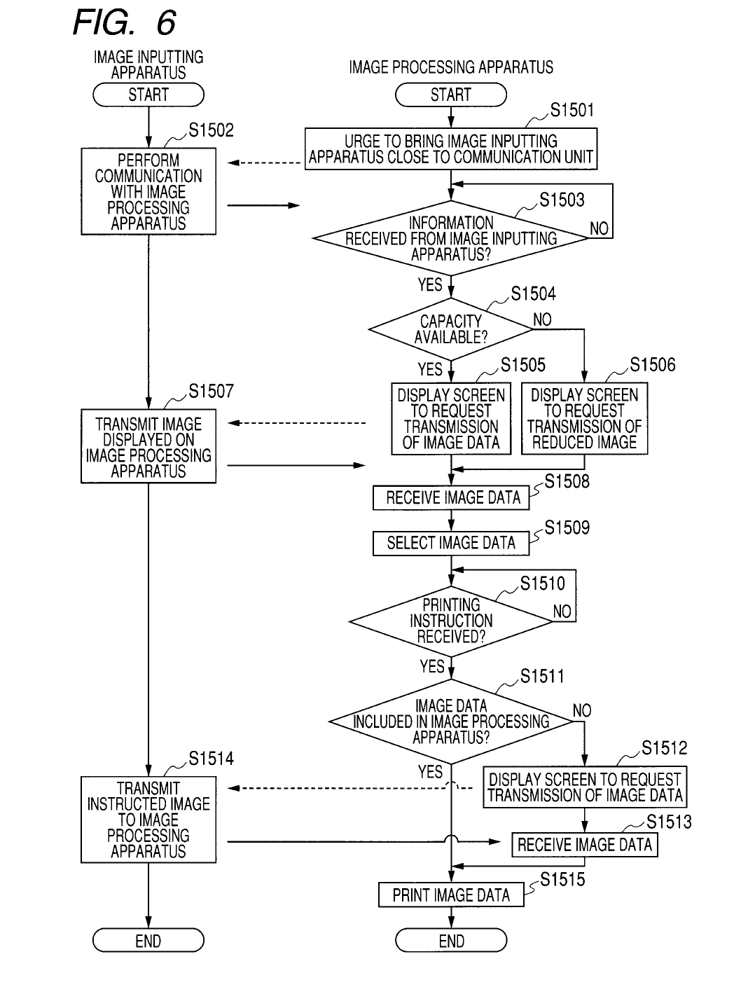

Subsequently, a control procedure in the image processing apparatus 100 and the image inputting apparatus 1000 will be described with reference to a flow chart illustrated in FIG. 6. Here, the process of the image inputting apparatus 1000 in the flow chart illustrated in FIG. 6 is performed if the CPU 1001 of the image inputting apparatus 1000 reads and performs the program stored in the ROM 1002. Further, the process of the image processing apparatus 100 in the flow chart illustrated in FIG. 6 is performed if the CPU 112 of the image processing apparatus 100 reads and performs the program stored in the ROM 114. Incidentally, it should be noted that, in the present embodiment, the MFP is used as an example of the image processing apparatus and the digital camera is used as an example of the image inputting apparatus.

Initially, in a case where a request for printing the image data in the image inputting apparatus 1000 such as the digital camera or the like is accepted from the user through the operation unit 250, a process in a step S1501 is performed.

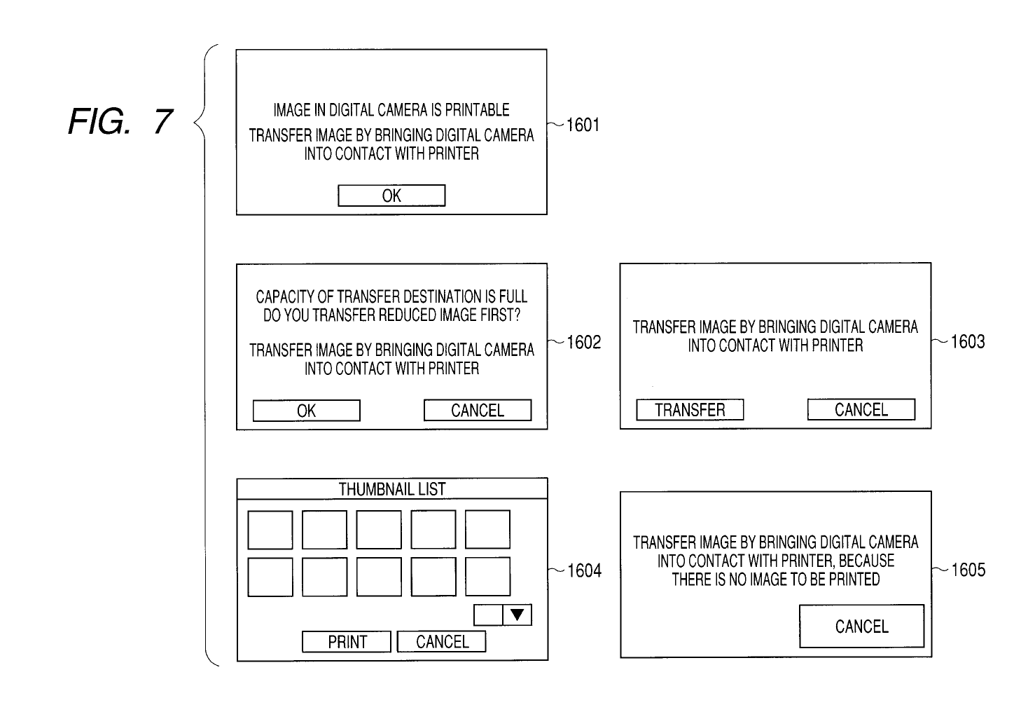

In the step S1501, as indicated by a screen 1601 illustrated in FIG. 7, the CPU 112 of the image processing apparatus 100 causes the operation unit 250 to display a message to urge the user to bring the digital camera 1000 into contact with the image processing apparatus 100. Here, the CPU 112 may cause the operation unit 250 to display a message to urge the user to bring the digital camera 1000 into contact with the communication unit 10. While the above message is being displayed, the CPU 112 waits for the information transmitted from the digital camera 1000. In any case, the user, who confirmed the above message, brings the digital camera 1000 close to the communication unit 10.

In a step S1502, the CPU 1001 of the digital camera 1000 observes whether or not the wireless communication unit 400 exists within the range capable of communicating with the wireless communication unit 1004. Then, if it is determined by the CPU 1001 that the wireless communication unit 400 exists within the range capable of communicating with the wireless communication unit 1004, the CPU 1001 causes the wireless communication unit 1004 to perform a process for connecting with the wireless communication unit 400. If the digital camera 1000 is connected with the image processing apparatus 100, the CPU 1001 transmits an apparatus ID of the digital camera 1000, size information of the image data to be transmitted, and the like to the image processing apparatus 100. Here, even in a case where the digital camera 1000 does not accept a transfer instruction from the user through the operation unit 1006, the digital camera 1000 transfers the apparatus ID of the digital camera, the size information of the image data to be transmitted, and the like to the image processing apparatus 100 only if the user brings the digital camera 1000 close to the communication unit 10.

In a step S1503, if the CPU 112 of the image processing apparatus 100 receives and obtains the apparatus ID of the digital camera, the size information of the image data to be transmitted, and the like from the digital camera 1000, the flow advances to a step S1504.

In the step S1504, the CPU 112 compares, based on the received size information of the image data, the size of the image data to be transmitted with an available capacity of the HDD 260. Then, if it is determined as a result of the comparison by the CPU 112 that there is the capacity available for storing the image data in the HDD 260, the flow advances to a step S1505. On the other hand, if it is determined by the CPU 112 that there is no capacity available for storing the image data in the HDD 260, the flow advances to a step S1506.

In the step S1505, as indicated by a screen 1603 illustrated in FIG. 7, the CPU 112 of the image processing apparatus 100 instructs the digital camera 1000 to transmit the image data. On the other hand, in the step S1506, as indicated by a screen 1602 illustrated in FIG. 7, the CPU 112 of the image processing apparatus 100 instructs the digital camera 1000 to transmit reduced image data of the image data (i.e., thumbnail images or the like).

In a step S1507, the CPU 1001 of the digital camera 1000 transmits to the image processing apparatus 100 the image data instructed by the image processing apparatus 100. Here, in the case where the image data is transmitted in response to the instruction issued in the step S1506, the image data to be actually transmitted is the reduced image data. On the other hand, in the case where the image data is transmitted in response to the instruction issued in the step S1505, the image data to be actually transmitted is the image data itself. Here, in a case where the image inputting apparatus 1000 does not have any reduced image data, the CPU 1001 performs a process to reduce the image data and then transmits the reduced image data to the image processing apparatus 100.

In a step S1508, the CPU 112 receives the image data transmitted from the digital camera 1000. Here, if the image data received is the image data transmitted in response to the instruction issued in the step S1506, the image data actually received is the reduced image data. On the other hand, if the image data received is the image data transmitted in response to the instruction issued in the step S1505, the image data actually received is the image data itself.

In a step S1509, as indicated by a screen 1604 illustrated in FIG. 7, the CPU 112 causes the operation unit 250 to display the reduced image data of the received image data so as to enable the user to select the image data to be printed, and then accepts the selection of the image by the user. Here, if the reduced image data is received in the step S1508, the CPU 112 causes the operation unit 250 to display the received image data. On the other hand, if the image data itself is received in the step S1508, the CPU 112 generates the reduced image data of the size capable of being displayed on the operation unit 250 from the received image data, and causes the operation unit 250 to display the generated reduced image data.

In a step S1510, the CPU 112 determines whether or not a printing instruction for the image data selected in the step S1509 is accepted from the user. More specifically, the CPU 112 determines whether or not the print button in the screen 1604 is depressed. In a case where it is determined by the CPU 112 that the printing instruction is accepted, the flow advances to a step S1511.

In the step S1511, the CPU 112 determines whether or not the image data for which the printing instruction is accepted is included in the HDD 260. More specifically, if only the reduced image data is received in the step S1509, the CPU 112 determines that the image data for which the printing instruction is accepted is not included in the HDD 260, and the flow advances to a step S1512. On the other hand, if the image data itself is received in the step S1509 and it is determined by the CPU 112 in the step S1511 that the image data for which the printing instruction is accepted is included in the HDD 260, the flow advances to a step S1515. In the step S1515, the CPU 112 causes the printer unit 300 to print the image data selected in the step S1509.

On the other hand, in the step S1512, the CPU 112 causes the operation unit 250 to display a screen 1605 illustrated in FIG. 7. While the message of the screen 1605 is being displayed, the CPU 112 waits for the operation that the user brings the image inputting apparatus 1000 close to the range capable of communicating with the wireless communication unit 400. In other words, the CPU 112 waits for the information transmitted from the digital camera 1000. Then, the user, who confirmed the above message, brings the digital camera 1000 close to the communication unit 10.

In a step S1514, the CPU 1001 transmits the image data instructed by the image processing apparatus 100 to the image processing apparatus 100.

In a step S1513, the CPU 112 receives the image data transmitted by the digital camera 1000. Then, the received image data is printed in the step S1515.

In the case where the printing is performed after the process in the steps S1512 to S1514, the image processing apparatus 100 receives, among the image data stored in the image inputting apparatus 1000, only the image data selected by the user. For this reason, the available capacity necessary is small as compared with the case where all the image data are received.

As described above, even if the user fetches the image data stored in the digital camera 1000 into the image processing apparatus 100 and does not leave the digital camera 1000 put on the communication unit 10, he/she can select the image data intended to be printed from the operation unit 250 of the image processing apparatus 100. Then, after the image data is selected, if the user disposes the digital camera 1000 to the communication unit 10 according to the instruction displayed on the operation unit 250, he/she can cause the image processing apparatus 100 to print the desired image. Thus, after the user disposes the digital camera 1000 to the communication unit 10, since he/she can have the digital camera 1000 close thereby while he/she is performing the operation for printing, the digital camera 1000 disposed to the communication unit 10 is not easily stolen by a thief. In addition, even if the user does not instruct transmission of the image by using the digital camera 1000, he/she can print the desired image only by bringing the digital camera 1000 close to the communication unit 10 of the image processing apparatus 100 according to the indication displayed on the operation unit 250.

Besides, in the step S1510, the CPU 112 accepts the selection of the image data intended to be printed. In addition, the CPU 112 may control to accept the print settings (the number of copies, designation of stapling, and the like) of the image data through the screen as illustrated in FIG. 4 displayed on the operation unit 250. In this case, the CPU 112 controls to store the accepted print settings in the HDD 260, and then print the image data received in the step S1508 or S1513 according to the stored print settings.

### Second Embodiment

Subsequently, the second embodiment of the present invention will be described.

In the second embodiment, a method of storing, in a case where a user performs print setting to image data transmitted from the image inputting apparatus 1000 to the image processing apparatus 100, the relevant print setting in the image inputting apparatus 1000 in relationship to the image data will be described. According to this method, if the user once performs the print setting to the image data, it is unnecessary for he/she on another occasion to again perform the same print setting even if he/she wishes to perform printing based on the same print setting.

In the present embodiment, since the hardware constitutions of the image processing apparatus 100 and the image inputting apparatus 1000 are the same as those already described in the first embodiment, the detailed description thereof will be omitted.

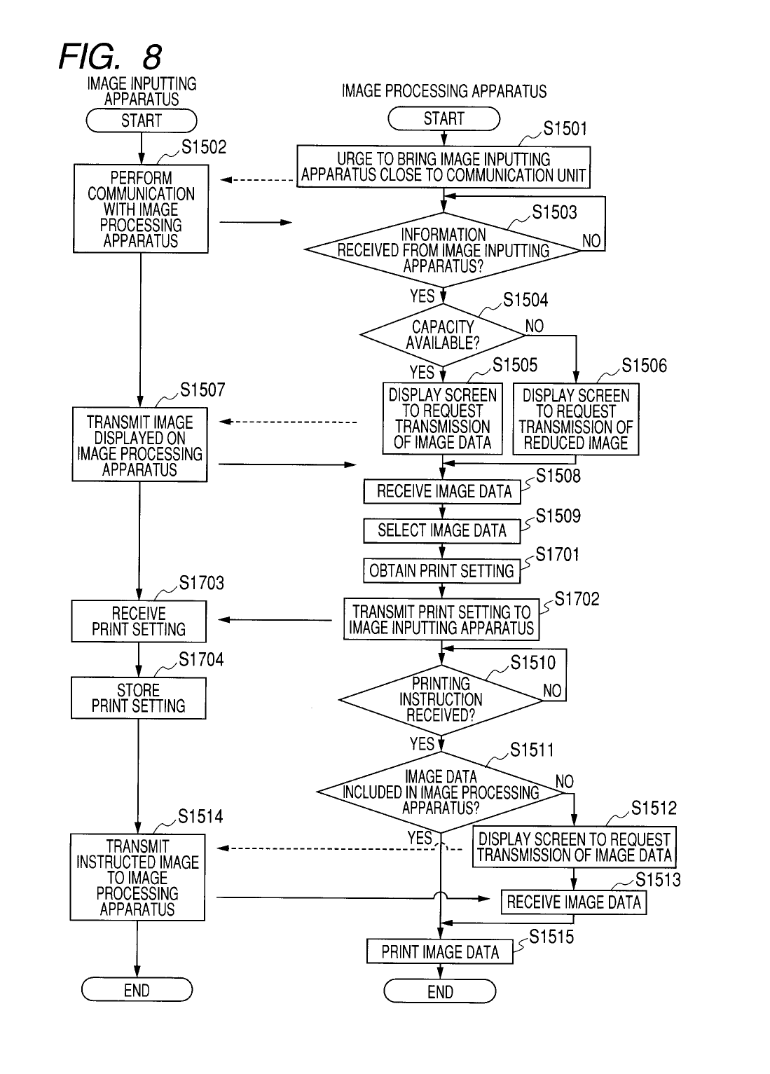

Further, in a flow chart illustrated in FIG. 8, the processes in the steps same as those described in the flow chart illustrated in FIG. 6 are indicated by the same step numbers as those illustrated in FIG. 6 respectively. Here, since the same process is performed in the steps having the same step number in FIGS. 6 and 8, the description of these steps in FIG. 8 will be omitted.

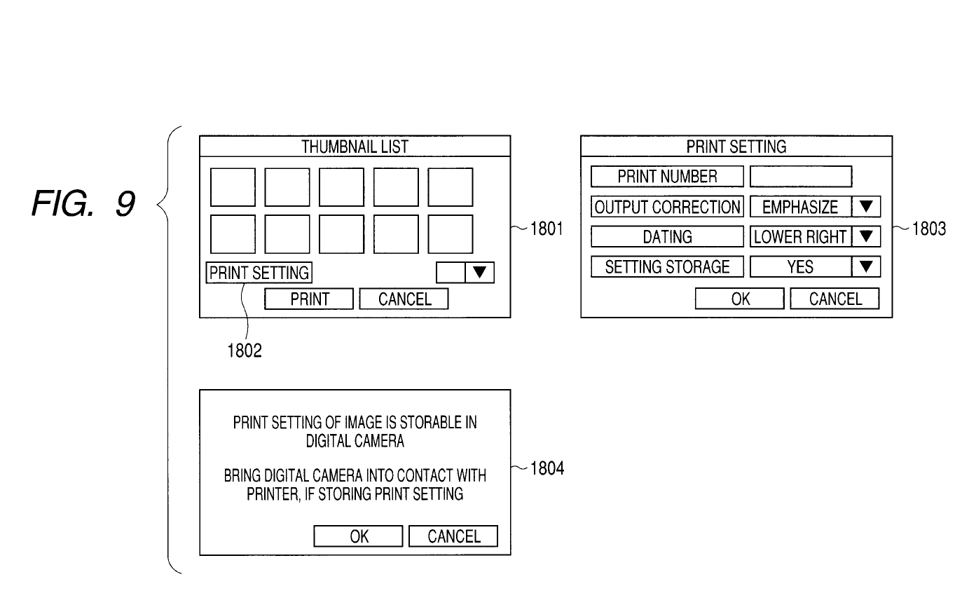

If the image data is received in a step S1508, the process advances to a step S1509. In the step S1509, the CPU 112 causes the operation unit 250 to display an operation screen 1801 illustrated in FIG. 9. More specifically, the operation unit 250 displays, on the operation screen 1809, the reduced image data of the received image data so as to enable the user to select the image data to be printed. Further, the CPU 112 causes the operation unit 250 to display a print setting key 1802 in the operation screen 1801 for displaying a print setting screen 1803 so as to accept from the user the print setting to the image data.

Subsequently, if the print setting key 1802 is depressed, in a step S1701, the CPU 112 causes the operation unit 250 to display the print setting screen 1803 so as to accept the print setting from the user. For example, the user can set the number of prints of the selected image data, output correction of the selected image data, dated printing of the selected image data, and the like on the print setting screen 1803. Incidentally, it should be noted that the print setting screen 1803 illustrated is an example of the screen on which the user can perform the print setting. Namely, the print setting screen, the print setting items and the like are not limited to those illustrated in FIG. 9. For example, the screen illustrated in FIG. 4 may be displayed on the operation unit 250 so as to enable the user to perform detailed setting through the displayed screen. Incidentally, it is possible to set whether or not to store the print setting by the user in the digital camera 1000 through a setting storage menu on the print setting screen 1803.

Then, if an OK key is depressed in the status that it has been set to store the print setting, the CPU 112 causes the operation unit 250 to display a screen 1804. Further, if the user brings the digital camera 1000 close to the communication unit 10 in this status, in a step S1702, the CPU 112 transmits the set print setting to the digital camera 1000 and instructs the digital camera 1000 to store the transmitted print setting in the secondary storage unit 1008.

Then, the digital camera 1000, which accepts such an instruction as described above in a step S1703, stores in a step S1704 the print setting received from the image processing apparatus 100 in the secondary storage unit 1008. Subsequently, in a case where the user again brings the digital camera 1000 close to the image processing apparatus 100 at another chance, the CPU 1001 of the digital camera 1000 transmits the print setting stored in the secondary storage unit 1008 to the image processing apparatus 100 at timing in a step S1507. Then, the image processing apparatus 100 displays the received print setting as the print setting screen on the operation unit 250 in the step S1701. In any case, in a case where the printing is performed in response to depression of the OK key by the user in a step S1515, the CPU 112 performs the printing according to the received print setting.

Here, since processes in a step S1510 and following steps are the same as those in the corresponding steps in the first embodiment, the detailed description thereof will be omitted.

According to such controlling as described above, after once performing the print setting to the image data, the user does not need to again perform the same print setting even if he/she wishes to perform at another chance the printing according to the print setting same as the previous print setting.

### Other Embodiments

In the above-described embodiments, in the step S1504, the CPU 112 may compare the data size indicated by the received size information with a data size predetermined as a threshold. Here, in a case where the CPU 112 determines that the data size indicated by the size information is equal to or smaller than the predetermined data size, the flow advances to the step S1505. On the other hand, in a case where the CPU 112 determines that the data size indicated by the size information is larger than the predetermined data size, the flow advances to the step S1506. Thus, the user can previously determine the capacity to be used to store the image data received from the image inputting apparatus, thereby being able to secure a storage area other than the area corresponding to the predetermined capacity for other processes such as an image process and the like.

Moreover, in the above-described embodiments, the CPU 1001 controls in the step S1507 to transmit to the image processing apparatus 100 all the printable image data (or the reduced image data of the image data) stored in the image inputting apparatus 1000. However, the present invention is not limited to this. For example, the CPU 1001 may control not to transmit the image data to which a transmission inhibited flag is added or the image data which is protected. Besides, the CPU 1001 may control to transmit, from among the image data stored in the image inputting apparatus 1000, only the image data to which a transmission flag is added to the image processing apparatus 100. Thus, the user can limit the image data intended to be transmitted to the image processing apparatus 100, whereby he/she can transmit only the desired image data to the image processing apparatus 100.

Moreover, in the above-described embodiments, the image data stored in the image inputting apparatus 1000 is printed on the side of the image processing apparatus 100. However, the present invention is not limited to this. For example, the present invention is also applicable to a case where the image data is transmitted to the external PC 4001, the external PC 4002 or the like, a case where the image data are accumulated in the image processing apparatus 100, and a case where the image process and the like are performed in the image processing apparatus 100. Also in these cases, even if the user does not leave the image inputting apparatus 1000 set in the vicinity of the communication unit 10, he/she can perform the operation to the image data stored in the image inputting apparatus 1000.

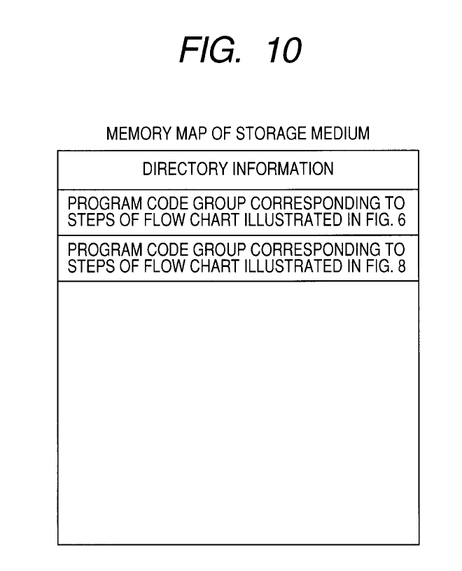

Hereinafter, the architecture of data processing programs readable by the image processing apparatus 100 according to the present invention will be explained with reference to a memory map illustrated in FIG. 10.

FIG. 10 is the diagram for describing the memory map of a storage medium which stores therein various data processing programs capable of being read by the image processing apparatus 100 according to the present invention.

Incidentally, although it is not illustrated specifically, also information (e.g., version information, creator information, etc.) for administrating the program groups stored in the storage medium may occasionally be stored in the storage medium, and information (e.g., icon information for discriminatively displaying the program, etc.) depending on an OS (operating system) or the like on the program reading side may occasionally be stored in the storage medium.

Moreover, the data depending on the various programs are administrated on the directory of the storage medium. Besides, a program to install the various programs into a computer, a program to uncompress or extract installed programs and data when the installed programs and data have been compressed, and the like may occasionally be stored.

Furthermore, the functions shown in the flow charts of this application may be performed by a host computer based on externally installed programs. In this case, the present invention is applicable even in a case where an information group including the programs is supplied from a storage medium (such as a CD-ROM, a flash memory, an FD or the like) or an external storage medium through a network to an outputting apparatus.

As described above, a computer-readable storage medium which stores therein program codes of software to realize the functions of the above-described embodiments may be supplied to a system or an apparatus. Further, it is needless to say that the object of the present invention can be achieved in a case where a computer (or CPU or MPU) in the system or the apparatus reads and performs the program codes stored in the storage medium.

In this case, the program codes themselves read from the storage medium achieve the new functions of the present invention, whereby the storage medium which stores these program codes constitutes the present invention.

As the storage medium for supplying the program codes, for example, a flexible disk, a hard disk, an optical disk, a magnetooptical disk, a CR-ROM, a CD-R, a magnetic tape, a nonvolatile memory card, a ROM, an EEPROM, or the like can be used.

Besides, the present invention is not limited only to the case where the functions of the above-described embodiments are realized by the program codes read and performed by the computer. For example, it is needless to say that the present invention also includes a case where an OS (operating system) or the like functioning on the computer performs a part or all of the actual processes according to instructions of the program codes, whereby the functions of the above-described embodiments are realized by that process.

While the present invention has been described with reference to what is presently considered to be the exemplary embodiments, it is to be understood that the present invention is not limited to the disclosed embodiments. On the contrary, the present invention is intended to cover various modifications and equivalent arrangements (including the organic combination of the respective embodiments) included within the spirit and scope of the appended claims. The scope of the following claims is to be accorded the broadest interpretation so as to encompass all such modifications and equivalent structures and functions.

This application claims the benefit of Japanese Patent Application No. 2008-171738, filed Jun. 30, 2008, which is hereby incorporated by reference herein in its entirety.

1. (canceled)

2. An image processing apparatus that can perform wireless communication with an image inputting apparatus, the image processing apparatus comprising:
an obtaining unit configured to obtain information of image data stored in the image inputting apparatus, according to a status indicating whether the image processing apparatus is able to communicate with the image inputting apparatus;
a selecting unit configured to select the image data to be printed based on the information obtained by the obtaining unit, in response to an instruction from a user;
an urging unit configured to display a message urging the user to bring the image inputting apparatus close to the image processing apparatus for receiving the image data selected by the selecting unit; and
a receiving unit configured to receive the image data selected by the selecting unit from the image inputting apparatus, according to the status indicating whether the image processing apparatus is able to communicate with the image inputting apparatus, after the urging unit displays the message urging the user to bring the image inputting apparatus close to the image processing apparatus.

3. The image processing apparatus according to claim 2, further comprising:
a storage unit configured to store the image data;
a determining unit configured to determine whether the image data can be stored in the storage unit, based on the information of the image data obtained by the obtaining unit; and
a storage control unit configured to control to store the image data in the storage unit, when the determining unit determines that the image data can be stored in the storage unit, and to control to store reduced image data of the image data in the storage unit, when the determining unit does not determine that the image data can be stored in the storage unit,
wherein the selecting unit causes the user to select the image data based on the image data or the reduced image data stored in the storage unit under the control of the storage control unit.

4. (canceled)

5. A control method for controlling an image processing apparatus capable of performing wireless communication with an image inputting apparatus, the method comprising:
obtaining information of image data stored in the image inputting apparatus, according to a status indicating whether the image processing apparatus is able to communicate with the image inputting apparatus;
selecting the image data to be printed based on the obtained information, in response to an instruction from a user;
displaying a message urging the user to bring the image inputting apparatus close to the image processing apparatus for receiving the selected image data; and
receiving the selected image data from the image inputting apparatus, according to the status indicating whether the image processing apparatus is able to communicate with the image inputting apparatus, after the displaying of the message urging the user to bring the image inputting apparatus close to the image processing apparatus.

6. The control method according to claim 5, further comprising:
determining whether the image data can be stored in a storage unit, based on the obtained information of the image data; and
controlling to store the image data in the storage unit, when a determination is made that the image data can be stored in the storage unit, and controlling to store reduced image data of the image data in the storage unit, when a determination is not made that the image data can be stored in the storage unit,
wherein the image data is selected based on the image data or the reduced image data stored in the storage unit.

7. (canceled)

8. A non-transitory computer-readable recording medium storing a computer-executable program for controlling an image processing apparatus capable of performing wireless communication with an image inputting apparatus, the computer-executable program comprising:
a code to obtain information of image data stored in the image inputting apparatus, according to a status indicating whether the image processing apparatus is able to communicate with the image inputting apparatus;
a code to select the image data to be printed based on the obtained information, in response to an instruction from a user;
a code to display a message urging the user to bring the image inputting apparatus close to the image processing apparatus for receiving the selected image data; and
a code to receive the selected image data from the image inputting apparatus, according to the status indicating whether the image processing apparatus is able to communicate with the image inputting apparatus, after the message urging the user to bring the image inputting apparatus close to the image processing apparatus is displayed.
